(19) United States
(12) Patent Application Publication
(10) Pub. No.: US 2015/0274956 A1
(43) Pub. Date: Oct. 1, 2015

(54) EMULSION FOR AQUEOUS COLOR, AND AQUEOUS COLOR COMPOSITION

(71) Applicant: NIPPON A&L INC., Osaka (JP)

(72) Inventor: Yuto MURAI, Niihama-shi (JP)

(73) Assignee: NIPPON A&L INC., Osaka (JP)

(21) Appl. No.: 14/659,871

(22) Filed: Mar. 17, 2015

(30) Foreign Application Priority Data
Mar. 31, 2014 (JP) 2014-070792

(51) Int. Cl. C08L 33/02

(52) U.S. Cl. CPC C08L 33/02

(57) ABSTRACT

The invention relates to an emulsion for aqueous color comprising polymer particles having an average particle size of 20 to 80 nm as measured by the photon correlation method, and including 0.1 to 7 wt % of a structural unit derived from an ethylene-based unsaturated carboxylic acid monomer as the monomer component.

### TECHNICAL FIELD

The present invention relates to an emulsion for aqueous color with transparency, and to an aqueous color composition. More specifically, the invention relates to an emulsion for aqueous color with transparency that more sharply exhibits color shades of developers such as pigments and the like, and that excels in reducing the difference in color shade before and after drying, as well as an aqueous color composition comprising the emulsion for aqueous color.

### BACKGROUND OF THE INVENTION

Aqueous color compositions come in a wide variety of types from transparent to semi-transparent, opaque and gouache, and these properties are closely related to the emulsions for aqueous color used in such color compositions.

For transparent uses, for example, the difference in color shade of the aqueous color composition before and after drying is a major issue, and therefore transparent emulsions for aqueous color are desired. However, in the prior art described in Japanese Unexamined Patent Application Publication No. 2006-193717, Japanese Unexamined Patent Application Publication No. 2006-225627 and Japanese Unexamined Patent Application Publication No. 2010-024391, the transparency is insufficient and it has thus been difficult to eliminate the difference in color shade before and after drying.

### SUMMARY

It is an object of the present invention to provide an emulsion for aqueous color that is transparent and that can produce an aqueous color composition having very low difference in color shade before and after drying, as well as the aqueous color composition.

As a result of much research directed toward accomplishing this object, it was found that it can be accomplished by reducing the particle sizes of the polymer particles obtained by polymerization and adding a structural unit derived from an ethylene-based unsaturated carboxylic acid monomer, and the invention has been completed upon this finding. In other words, the invention provides an emulsion for aqueous color comprising polymer particles having an average particle size of 20 to 80 nm according to the photon correlation method, and including 0.1 to 7 wt % of a structural unit derived from an ethylene-based unsaturated carboxylic acid monomer as the monomer component.

According to the invention it is possible to provide an emulsion for aqueous color that is transparent and that can produce an aqueous color composition having very low difference in color shade before and after drying, as well as the aqueous color composition.

### DETAILED DESCRIPTION OF THE INVENTION

The present invention will now be explained in greater detail. The emulsion for aqueous color of the embodiment comprises polymer particles having an average particle size of 20 to 80 nm according to the photon correlation method, and including 0.1 to 7 wt % of a structural unit derived from an ethylene-based unsaturated carboxylic acid monomer.

The polymer particles in the emulsion for aqueous color of the embodiment are obtained by copolymerizing an ethylene-based unsaturated carboxylic acid monomer as the essential component, and as optional components, an ethylene-based unsaturated alkyl carboxylate ester monomer and another monomer that is copolymerizable with them.

Ethylene-based unsaturated carboxylic acid monomers include mono and dicarboxylic acids such as acrylic acid, methacrylic acid, crotonic acid, maleic acid, fumaric acid and itaconic acid (or their anhydrides), and any one or more of these may be used. It is particularly preferred to use acrylic acid or methacrylic acid. The amount of the ethylene-based unsaturated carboxylic acid monomer must be 0.1 to 7 wt %, where the total amount of the total monomers is 100 wt %. If it is less than 0.1 wt % the polymerization stability and dispersion stability will tend to be poor, while if it exceeds 7 wt %, transparency will be poor and the viscosity of the emulsion for aqueous color itself will increase, tending to reduce the manageability. The amount of the ethylene-based unsaturated carboxylic acid monomer is preferably 0.3 to 3 wt % and more preferably 0.5 to 2.5 wt %. The amount of the ethylene-based unsaturated carboxylic acid monomer may also be 1.5 to 7 wt %, or 3 to 5 wt %.

Ethylene-based unsaturated alkyl carboxylate ester monomers include methyl acrylate, methyl methacrylate, ethyl acrylate, ethyl methacrylate, butyl acrylate, glycidyl methacrylate, dimethyl fumarate, diethyl fumarate, dimethyl maleate, diethyl maleate, dimethyl itaconate, monomethyl fumarate, monoethyl fumarate and 2-ethylhexyl acrylate, any one or more of which may be used. Butyl acrylate and methyl methacrylate are particularly preferred for use.

The amount of the ethylene-based unsaturated alkyl carboxylate ester monomer is preferably 60 to 99.9 wt %, more preferably 70 to 99.7 wt % and even more preferably 80 to 99.5 wt % (where the total of all of the monomers is 100 wt%), from the viewpoint of the texture and transparent quality of the dried aqueous color composition. The amount of the ethylene-based unsaturated alkyl carboxylate ester monomer may also be 60 to 98.5 wt %, or 80 to 97 wt %.

The other monomer that is copolymerizable with the ethylene-based unsaturated carboxylic acid monomer and the ethylene-based unsaturated alkyl carboxylate ester monomer may be an aromatic vinyl monomer, an aliphatic conjugated diene-based monomer, a vinyl cyanide-based monomer, a hydroxyalkyl group-containing ethylene-based unsaturated monomer, an ethylene-based unsaturated carboxylic acid amide monomer, or the like.

Aromatic vinyl-based monomers include styrene, α-methylstyrene, methyl α-methylstyrene, vinyltoluene and divinylbenzene, any one or more of which may be used.

Aliphatic conjugated diene-based monomers include 1,3-butadiene, 2-methyl-1,3-butadiene, 2,3-dimethyl-1,3-butadiene, 2-chlor-1,3-butadiene, substituted straight-chain conjugated pentadienes, substituted and side chain-conjugated hexadienes and the like, any one or more of which may be used. It is particularly preferred to use 1,3-butadiene.

Vinyl cyanide-based monomers include acrylonitrile, methyacrylonitrile, α-chloracrylonitrile and α-ethylacrylonitrile, any one or more of which may be used. It is particularly preferred to use acrylonitrile or methyacrylonitrile.

Hydroxyalkyl group-containing ethylene-based unsaturated monomers include β-hydroxyethyl acrylate, β-hydroxyethyl methacrylate, hydroxypropyl acrylate, hydroxypropyl methacrylate, hydroxybutyl acrylate, hydroxybutyl methacrylate, 3-chloro-2-hydroxypropyl methacrylate, di-(ethylene glycol)maleate, di-(ethylene glycol)itaconate, 2-hydroxyethyl maleate, bis(2-hydroxyethyl)maleate and 2-hydroxyethylmethyl fumarate, any one or more of which may be used.

Ethylene-based unsaturated carboxylic acid amide monomers include acrylamide, methacrylamide, N-methylolacrylamide, N-methylolmethacrylamide and N,N-dimethylacrylamide, any one or more of which may be used.

The amount of the other monomer that is copolymerizable with the ethylene-based unsaturated carboxylic acid monomer and the ethylene-based unsaturated alkyl carboxylate ester monomer is preferably 0 to 39.9 wt %, more preferably 0 to 29.7 wt % and even more preferably 0 to 19.5 wt % (where the total of all of the monomers is 100 wt %), from the viewpoint of the texture and transparent quality of the dried aqueous color composition. The amount of the other monomer that is copolymerizable with the ethylene-based unsaturated carboxylic acid monomer and the ethylene-based unsaturated alkyl carboxylate ester monomer may also be 0 to 38.5 wt %, or 0 to 17 wt %.

The emulsion for aqueous color of the embodiment can be produced by a publicly known emulsion polymerization method, and for production of the emulsion for aqueous color there may be used publicly known emulsifying agents, chain transfer agents, polymerization initiators, reducing agents, electrolytes, polymerization promoters, chelating agents and the like, while a hydrocarbon-based solvent may also be used. There are no particular restrictions on the method of adding each of the monomers to be used for polymerization and the other additives, and for example, a batch addition method, divided addition method or continuous addition method may be employed.

The emulsifying agent to be used for emulsion polymerization may be a nonionic surfactant, such as an alkali metal salt of oleic acid, an alkali metal salt of a rosin acid, an alkali metal salt of formalin naphthalenesulfonate condensate, an alkali metal salt of a higher alcohol sulfate, an alkali metal salt of alkylbenzenesulfonic acid, an alkali metal salt of an alkyldiphenylether sulfonic acid, an alkali metal salt of an aliphatic sulfonic acid, an alkali metal salt of a nonionic surfactant sulfuric acid ester, or an alkyl ester-type, alkylphenyl ether-type or alkyl ether-type polyethylene glycol, and any one or more of these may be used. There are no particular restrictions on the amount of these emulsifying agents, but they will normally be used at 0.1 to 3 parts by weight with respect to 100 parts by weight of the monomer component.

Chain transfer agents to be used for emulsion polymerization include alkylmercaptanes such as n-hexylmercaptane, n-octylmercaptane, t-octylmercaptane, n-dodecylmercaptane, t-dodecylmercaptane and n-stearylmercaptane, xanthogen compounds such as dimethylxanthogen disulfide and diisopropylxanthogen disulfide, α-methylstyrene dimer, terpinolene, thiuram-based compounds such as tetramethylthiuram disulfide, tetraethylthiuram disulfide and tetramethylthiuram monosulfide, phenol-based compounds such as 2,6-di-t-butyl-4-methylphenol and styrenated phenols, allyl compounds such as allyl alcohol, halogenated hydrocarbon compounds such as dichlormethane, dibromomethane and carbon tetrabromide, vinyl ethers such as α-benzyloxystyrene, α-benzyloxyacrylonitrile and α-benzyloxyacrylamide, and triphenylethane, pentaphenylethane, acrolein, methacrolein, thioglycolic acid, thiomalic acid, 2-ethylhexylthioglycolate and the like, any one or more of which may be used. There are no particular restrictions on the amounts of these chain transfer agents, but they will normally be used at 0 to 5 parts by weight with respect to 100 parts by weight of the monomer component.

The polymerization initiator to be used for emulsion polymerization may be a water-soluble polymerization initiator such as potassium persulfate, sodium persulfate or ammonium persulfate, or an oil-soluble polymerization initiator such as cumene hydroperoxide, benzoyl peroxide, t-butyl hydroperoxide, acetyl peroxide, diisopropylbenzene hydroperoxide or 1,1,3,3-tetramethylbutyl hydroperoxide, selected for use as appropriate. Particularly preferred for use are water-soluble polymerization initiators such as potassium persulfate or sodium persulfate and oil-soluble polymerization initiators such as cumene hydroperoxide.

A reducing agent is preferably added together with the polymerization initiator in the emulsion polymerization reaction system, so that the reaction rate is promoted without reducing the transparency of the emulsion for aqueous color.

Specific examples of reducing agents include sulfurous acid salts, hydrogen sulfite salts, pyrosulfurous acid salts, dithionous acid salts, dithionic acid salts and thiosulfuric acid salts, as well as reducing sulfonic acid salts such as formaldehydesulfonic acid salts and benzaldehydesulfonic acid salts, carboxylic acids such as L-ascorbic acid, tartaric acid and citric acid, reducing sugars such as dextrose and saccharose, and amines such as dimethylaniline and triethanolamine. Particularly preferred are sodium sulfite, sodium formaldehydesulfonate and L-ascorbic acid.

Hydrocarbon compounds may be used during the emulsion polymerization, including saturated hydrocarbons such as pentane, hexane, heptane, octane, cyclohexane and cycloheptane, unsaturated hydrocarbons such as pentene, hexene, heptene, cyclopentene, cyclohexene, cycloheptene, 4-methylcyclohexene and 1-methylcyclohexene, and aromatic hydrocarbons such as benzene, toluene and xylene. Particularly suitable from the viewpoint of environmental issues are cyclohexene and toluene, since they have appropriately low boiling points, and are recoverable by steam distillation after polymerization is complete, and are thus easy to reuse.

The polymer particles in the emulsion for aqueous color of the embodiment have small particle sizes, and must have average particle sizes of 20 to 80 nm as measured by the photon correlation method. If the average particle size exceeds 80 nm the transparency will be poor, and if it is less than 20 nm it will be difficult to form smaller particles. The average particle size of the polymer particle is preferably 25 to 60 nm and more preferably 30 to 50 nm.

There are no particular restrictions on the method for obtaining the emulsion for aqueous color of the embodiment, and there may be employed a method of using a lot of surfactants to raise the micelle concentration, a method of generating initiating radicals, or a method of preventing generation of seed particles. It is particularly preferred to use a method of polymerization without formation of seed particles before the start of polymerization, from the standpoint of obtaining small polymer particle sizes.

The emulsion for aqueous color of the embodiment is, for example, a dispersion of the aforementioned polymer particles in a medium such as water. The solid concentration of the emulsion for aqueous color is preferably 20 to 50 wt % and more preferably 25 to 45 wt %, from the viewpoint of cost incurred during transport and tank volume during storage.

The aqueous color composition of the embodiment comprises an emulsion for aqueous color of the embodiment. The aqueous color composition of the embodiment preferably comprises the emulsion for aqueous color of the embodiment at 0.1 to 50 wt % (solid content), where the aqueous color composition is defined as 100 wt % (solid content). If the content is less than 0.1 wt % the film formability will be poor, and if it is greater than 50 wt % the colorability will be poor.

The aqueous color composition of the embodiment further comprises a pigment. Examples of pigments to be used include inorganic pigments such as carbon black, aniline black, iron black, calcium carbonate, kaolin clay, talc, barium sulfate, titanium oxide, aluminum hydroxide, zinc oxide and satin white, and organic pigments such as azo-based pigments, naphthol-based pigments, phthalocyanine-based pigments, threne-based pigments and quinacridone-based pigments, either alone or in admixture.

The weight proportion of the pigment in the aqueous color composition is preferably 5 to 60 wt % (solid content), where the aqueous color composition is defined as 100 wt % (solid content). At lower than 5 wt % the colorability will be poor, and at greater than 60 wt % the composition will have poor spreadability when the aqueous color composition is used.

The aqueous color composition of the embodiment may also have various other auxiliary agents, such as antifoaming agents, moistening agents, antiseptic agents, viscosity modifiers, dispersing agents or film reinforcers, added as necessary.

### EXAMPLES

The invention will now be explained in greater detail by examples, with the understanding that the invention is not limited to these examples so long as the gist thereof is maintained. Throughout the examples, the parts and percentage values indicating the contents are based on weight unless otherwise specified.

Preparation of Emulsion for Aqueous Color A

Into a 5 liter polymerization reactor there were charged 150 parts of purified water and 1 part of sodium dodecylbenzenesulfonate, and the temperature was raised to 70° C. while stirring. Next, 1 part of potassium persulfate was added to start the reaction. Immediately after the start of polymerization, 46 parts of butyl acrylate, 48 parts of methyl methacrylate, 6 parts of acrylic acid, 0.5 part of sodium dodecylbenzenesulfonate and 10 parts of water were added in a continuous manner over a period of 5 hours, and upon reaching a polymerization conversion rate of ≧98%, polymerization was stopped to obtain emulsion for aqueous color A.

Preparation of Emulsion for Aqueous Color B

Into a 5 liter polymerization reactor there were charged 150 parts of purified water and 1.5 parts of sodium dodecylbenzenesulfonate, and the temperature was raised to 70° C. while stirring. Next, 1 part of potassium persulfate was added to start the reaction. Immediately after the start of polymerization, 43 parts of butyl acrylate, 52 parts of methyl methacrylate, 5 parts of acrylic acid, 0.5 part of sodium dodecylbenzenesulfonate and 10 parts of water were added in a continuous manner over a period of 6 hours, and upon reaching a polymerization conversion rate of ≧98%, polymerization was stopped to obtain emulsion for aqueous color B.

Preparation of Emulsion for Aqueous Color C

Into a 5 liter polymerization reactor there were charged 150 parts of purified water and 2 parts of sodium dodecylbenzenesulfonate, and the temperature was raised to 70° C. while stirring. Next, 1.0 part of potassium persulfate was added to start the reaction. Immediately after the start of polymerization, 47 parts of butyl acrylate, 49 parts of methyl methacrylate, 4 parts of acrylic acid, 0.5 part of sodium dodecylbenzenesulfonate and 10 parts of water were added in a continuous manner over a period of 6 hours, and upon reaching a polymerization conversion rate of ≧98%, polymerization was stopped to obtain emulsion for aqueous color C.

Preparation of Emulsion for Aqueous Color D

Into a 5 liter polymerization reactor there were charged 150 parts of purified water and 2 parts of sodium dodecylbenzenesulfonate, and the temperature was raised to 70° C. while stirring. Next, 1.0 part of potassium persulfate was added to start the reaction. Immediately after the start of polymerization, 47.5 parts of butyl acrylate, 49 parts of methyl methacrylate, 3.5 parts of methacrylic acid, 0.5 part of sodium dodecylbenzenesulfonate and 10 parts of water were added in a continuous manner over a period of 6 hours, and upon reaching a polymerization conversion rate of ≧98%, polymerization was stopped to obtain emulsion for aqueous color D.

Preparation of Emulsion for Aqueous Color E

Into a 5 liter polymerization reactor there were charged 150 parts of purified water and 2 parts of sodium dodecylbenzenesulfonate, and the temperature was raised to 70° C. while stirring. Next, 1 part of potassium persulfate was added to start the reaction. Immediately after the start of polymerization, 44 parts of butyl acrylate, 54 parts of methyl methacrylate, 2 parts of methacrylic acid, 0.5 part of sodium dodecylbenzenesulfonate and 10 parts of water were added in a continuous manner over a period of 5 hours, and upon reaching a polymerization conversion rate of ≧98%, polymerization was stopped to obtain emulsion for aqueous color E.

Preparation of Emulsion for Aqueous Color F

Into a 5 liter polymerization reactor there were charged 150 parts of purified water and 2 parts of sodium dodecylbenzenesulfonate, and after further adding 4.9 parts of butyl acrylate, 5 parts of methyl methacrylate and 0.2 part of acrylic acid, the temperature was raised to 70° C. while stirring. Next, 1 part of potassium persulfate was added to start the reaction. Immediately after the start of polymerization, 43.5 parts of butyl acrylate, 44.6 parts of methyl methacrylate, 1.8 parts of acrylic acid, 0.5 part of sodium dodecylbenzenesulfonate and 10 parts of water were added in a continuous manner over a period of 5 hours, and upon reaching a polymerization conversion rate of ≧98%, polymerization was stopped to obtain emulsion for aqueous color F.

Preparation of Emulsion for Aqueous Color G

Into a 5 liter polymerization reactor there were charged 150 parts of purified water and 1 part of sodium dodecylbenzenesulfonate, and the temperature was raised to 70° C. while stirring. Next, 1 part of potassium persulfate was added to start the reaction. Immediately after the start of polymerization, 45 parts of butyl acrylate, 47 parts of methyl methacrylate, 8 parts of acrylic acid, 0.5 part of sodium dodecylbenzenesulfonate and 10 parts of water were added in a continuous manner over a period of 5 hours, and upon reaching a polymerization conversion rate of ≧98%, polymerization was stopped to obtain emulsion for aqueous color G.

Preparation of Emulsion for Aqueous Color H

Into a 5 liter polymerization reactor there were charged 150 parts of purified water and 2 parts of sodium dodecylbenzenesulfonate, and after further adding 4.6 parts of butyl acrylate, 4.8 parts of methyl methacrylate and 0.6 part of acrylic acid, the temperature was raised to 70° C. while stirring. Next, 0.7 part of potassium persulfate was added to start the reaction. Immediately after the start of polymerization, 41.4 parts of butyl acrylate, 43.2 parts of methyl methacrylate, 5.4 parts of acrylic acid, 0.5 part of sodium dodecylbenzenesulfonate and 10 parts of water were added in a continuous manner over a period of 5 hours, and upon reaching a polymerization conversion rate of ≧98%, polymerization was stopped to obtain emulsion for aqueous color H.

Preparation of Emulsion for Aqueous Color I

Into a 5 liter polymerization reactor there were charged 150 parts of purified water and 2 parts of sodium dodecylbenzenesulfonate, and the temperature was raised to 70° C. while stirring. Next, 1.0 part of potassium persulfate was added to start the reaction. Immediately after the start of polymerization, 50 parts of butyl acrylate, 50 parts of methyl methacrylate, 0.5 part of sodium dodecylbenzenesulfonate and 10 parts of water were added in a continuous manner over a period of 5 hours. However, visible polymer aggregates precipitated at about 1 hour before the continuous addition was complete, and it was not possible to obtain emulsion for aqueous color I in a stabilized dispersed state.

Preparation of Emulsion for Aqueous Color J

Into a 5 liter polymerization reactor there were charged 150 parts of purified water and 1 part of sodium dodecylbenzenesulfonate, and the temperature was raised to 70° C. while stirring. Next, 1 part of potassium persulfate was added to start the reaction. Immediately after the start of polymerization, 49 parts of butyl acrylate, 50 parts of methyl methacrylate, 1 part of acrylic acid, 0.5 part of sodium dodecylbenzenesulfonate and 10 parts of water were added in a continuous manner over a period of 6 hours, and upon reaching a polymerization conversion rate of >98%, polymerization was stopped to obtain emulsion for aqueous color J.

Measurement of Average Particle Size of Polymer Particles in Emulsion for Aqueous Color, by Photon Correlation Method

The average particle sizes of the polymer particles in the emulsion for aqueous color were measured by the photon correlation method. The measurement was conducted using an FPAR-1000 (Otsuka Electronics Co., Ltd.) (JIS Z8826).

Measurement and Evaluation of Transmittance of Emulsion for Aqueous Color

The solid content of each emulsion was adjusted to 35.0±1.0% with purified water, and the transmittance was calculated based on Formula 1 below, from the absorbance at a wavelength of 700 nm measured using a UVmini-1240 (Shimadzu Corp.). A higher calculated transmittance corresponds to more satisfactory transparency.

A=−log₁₀T Formula 1

A: Absorbance, T: Transmittance

Table 1 shows the results for the amounts of structural units derived from the ethylene-based unsaturated carboxylic acid monomers in the polymer particles of the emulsions for aqueous color obtained by the method described above (i.e. the carboxylic acid contents), the average particle sizes as measured by photon correlation, and the transmittances.

TABLE 1

| | | | | | | | Comparative | | |
|---|---|---|---|---|---|---|---|---|---|
| | Example | | | | | | Example | | |
| | Emulsion for aqueous acrylic color | | | | | | | | |
| | A | B | C | D | E | J | F | G | H |
| Carboxylic acid content | 6 | 5 | 4 | 3.5 | 2 | 1 | 2 | 8 | 6 |
| [parts] | | | | | | | | | |
| Average particle size | 77 | 55 | 34 | 39 | 38 | 34 | 90 | 78 | 105 |
| [nm] | | | | | | | | | |
| Transmittance | 50 | 56 | 63 | 65 | 65 | 64 | 35 | 40 | 10 |
| [%] | | | | | | | | | |

As shown in Table 1, the carboxylic acid contents and average particle sizes were within the range of the invention with the emulsions for aqueous color A to E and J of the examples, and the transparencies were very excellent.

With comparative example emulsions for aqueous color F to H, on the other hand, either the carboxylic acid contents or average particle sizes did not conform to the invention, and therefore the transparencies were significantly inferior.

### INDUSTRIAL APPLICABILITY

As explained above, the invention can provide an emulsion for aqueous color with very excellent transparency, so that an aqueous color composition can be obtained having satisfactory pigment coloring properties and very low difference in color shade before and after drying.

What is claimed is:

1. An emulsion for aqueous color comprising polymer particles having an average particle size of 20 to 80 nm as measured by the photon correlation method, and including 0.1 to 7 wt % of a structural unit derived from an ethylene-based unsaturated carboxylic acid monomer as the monomer component.

2. The emulsion for aqueous color according to claim 1, wherein the average particle size of the polymer particles is 25 to 60 nm as measured by the photon correlation method.

3. An aqueous color composition comprising an emulsion for aqueous color according to claim 1, and a pigment.

4. An aqueous color composition comprising an emulsion for aqueous color according to claim 2, and a pigment.
